(19) United States
(12) Patent Application Publication
(10) Pub. No.: US 2014/0134578 A1
(43) Pub. Date: May 15, 2014

(54) Tailored Airline Training

(71) Applicant: The Boeing Company, (US)

(72) Inventors: Jason W. Clark, Highlands Ranch, CO (US); Samantha Ann Schwartz, Castle Pines, CO (US); Wojciech Bojanowski, Gdynia (PL); Dariusz Niklewicz, Rumia (PL)

(73) Assignee: THE BOEING COMPANY, Chicago, IL (US)

(21) Appl. No.: 13/675,811

(22) Filed: Nov. 13, 2012

(51) Int. Cl. G09B 19/00

(52) U.S. Cl. CPC G09B 19/00
USPC 434/219

(57) ABSTRACT

A method and apparatus for identifying training for a flight crew member. The flight crew member is identified. Information for a flight to which the flight crew member is assigned is identified. Training for the flight crew member is identified using the flight information.

### BACKGROUND INFORMATION

1. Field

The present disclosure relates generally to systems and methods for training. More particularly, the present disclosure relates to tailoring training for a member of a flight crew using information describing characteristics of a flight to which the crew member is assigned.

2. Background

Pilots and other members of a flight crew may be required to take various training courses. The content of these courses, and how often the courses are required to be taken, may be defined by an airline or other employer of the flight crew, by a regulatory entity, or both.

Flight crew members may be required to complete specific training courses within a specified time period or before a specified time of the year. For example, an airline may have targeted training for their crews to take for winter operations and for summer operations. Training courses for winter operations may include training for de-icing, use of anti-ice equipment, hold over times, other activities, or various combinations of activities that are more likely to be performed by the flight crew for flights during the winter. Training courses for summer operations may include training for avoiding thunderstorms, performance, summer passenger weights, other activities, or various combinations of activities that are more likely to be performed by the flight crew for flights during the summer.

It may also be desirable for flight crew members to train for specific skills that may be useful for specific upcoming flights to which the flight crew members are assigned, even if such training is not required. For example, if required training for a specific skill was completed a relatively long time ago, it may be desirable for the flight crew to retake or update some or all of the training for that skill if that skill is likely to be used during an upcoming flight to which the crew is assigned.

Currently, the same training courses and schedules for such training may be established by an airline for all personnel with the same position on a flight crew. For example, an airline may require all pilots to take the same training courses over the same time period or during the same time of year. In this case, pilot training may not be tailored efficiently to the particular training needs of individual pilots.

Accordingly, it would be beneficial to have a method and apparatus that takes into account one or more of the issues discussed above as well as possibly other issues.

### SUMMARY

An illustrative embodiment of the present disclosure provides a method for identifying training for a flight crew member. The flight crew member is identified. Information for a flight to which the flight crew member is assigned is identified. Training for the flight crew member is identified using the flight information.

Another illustrative embodiment of the present disclosure provides an apparatus comprising an information receiver and a training identifier. The information receiver is configured to receive task information identifying characteristics of a task to be performed by a trainee. The training identifier is configured to identify training for the trainee using the task information.

Another illustrative embodiment of the present disclosure provides a method for identifying training for a trainee. The trainee is identified. Task information identifying characteristics of a task to be performed by the trainee is identified. Training for the trainee is identified using the task information.

The features, functions, and benefits may be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of illustrative embodiments of the present disclosure when read in conjunction with the accompanying drawings, wherein:

FIG. 1 is an illustration of a block diagram of a training environment in accordance with an illustrative embodiment;

FIG. 2 is an illustration of a block diagram of a training system in accordance with an illustrative embodiment;

FIG. 3 is an illustration of a block diagram of flight information in accordance with an illustrative embodiment;

FIG. 4 is an illustration of a flowchart of a process for identifying training in accordance with an illustrative embodiment; and

FIG. 5 is an illustration of a block diagram of a data processing system in accordance with an illustrative embodiment.

### DETAILED DESCRIPTION

The different illustrative embodiments recognize and take into account a number of different considerations. “A number,” as used herein with reference to items, means one or more items. For example, “a number of different considerations” means one or more different considerations.

The different illustrative embodiments recognize and take into account that current airline training systems may use a static set of training content that does not take individual flight crew member context and operational environment into account. As a result, current training systems may not provide training for individual flight crew members in an efficient manner.

For example, a pilot may be required to take a training course on de-icing in a certain time period because all of the pilots for the airline are required to take the same training courses within the same time period. However, all of the flights for which the pilot is scheduled during the time period may be in tropical areas where icing cannot occur. In this case, it would be more efficient if the training for de-icing was deferred until the pilot is scheduled for a flight in an area where icing may occur. Furthermore, in this case, it may be desirable for the pilot to take training that may be specific for flights in tropical areas, particularly if the pilot has not participated in such training recently.

The illustrative embodiments provide a system and method for supplying training to flight crew members in a more efficient and effective manner. In accordance with an illustrative embodiment, the training content and the timing at which the training is provided may be tailored for an individual flight crew member based on characteristics of the flight crew member and characteristics of the flights to which the flight crew member is assigned.

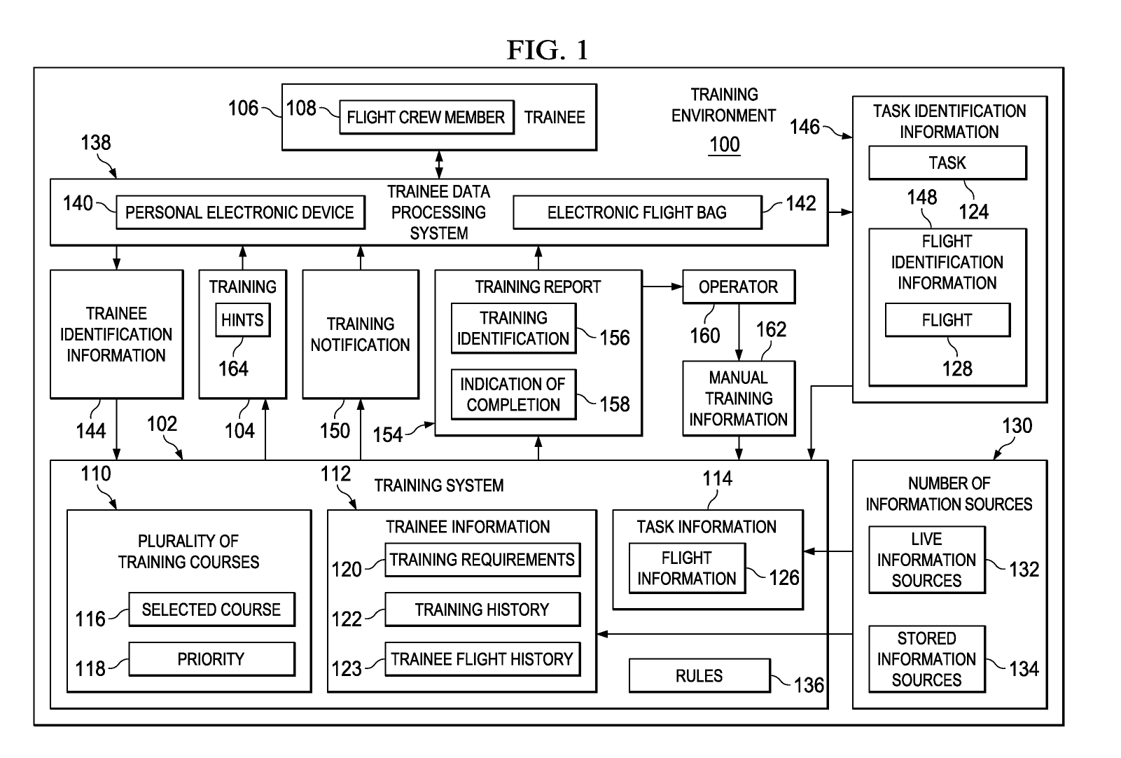

Turning now to FIG. 1, an illustration of a block diagram of a training environment is depicted in accordance with an illustrative embodiment. In this example, training environment 100 includes training system 102. In accordance with an illustrative embodiment, training system 102 may be configured to identify training 104 for trainee 106.

For example, without limitation, trainee 106 may be flight crew member 108. For example, flight crew member 108 may be a pilot, co-pilot, or other member of a flight crew for a commercial or other aircraft.

It may be desirable for trainee 106 to take plurality of training courses 110. For example, without limitation, plurality of training courses 110 may include a number of courses covering a variety of subjects. Plurality of training courses 110 may include training that flight crew member 108 may be required to take over a specified time period. For example, without limitation, plurality of training courses 110, and the time period for taking plurality of training courses 110, may be defined by an airline or other employer of flight crew member 108, by a regulatory entity, or by another entity or various combinations of such entities. Plurality of training courses 110 may include any type or form of training. For example, without limitation, plurality of training courses 110 may include classroom training, on-line training, self-study, or any other form of training or various types of training in various combinations.

In accordance with an illustrative embodiment, training system 102 may be configured to identify training 104 for trainee 106 using trainee information 112 and task information 114. For example, without limitation, training system 102 may be configured to identify selected course 116 from plurality of training courses 110 using trainee information 112 and task information 114. Selected course 116 may be the most desirable one of plurality training courses 110 for trainee 106 to take based on trainee information 112 and task information 114. As another example, training system 102 may be configured to identify priority 118 of plurality of training courses 110 for trainee 106 using trainee information 112 and task information 114. Priority 118 of plurality of training courses 110 may identify the most desirable order in which trainee 106 should take plurality of training courses 110 based on trainee information 112 and task information 114.

Trainee information 112 may include any information identifying various characteristics of trainee 106 that may be used by training system 102 to identify training 104 for trainee 106. For example, without limitation, trainee information 112 may include training requirements 120, training history 122, trainee flight history 123, or other appropriate information or various combinations of such information. Training requirements 120 may include, without limitation, a listing of training that trainee 106 may be required to take. For example, without limitation, training requirements 120 may identify a number of plurality of training courses 110 that trainee 106 may be required to take. Training requirements 120 also may identify a time during which or by which trainee 106 may be required to take the listed training. Training history 122 may identify training that trainee 106 has already taken. Training history 122 also may identify when trainee 106 took the identified training. Trainee flight history 123 may identify flights on which flight crew member 108 trainee 106 has recently served and various characteristics of those flights. Trainee information 112 may be stored in training system 102, at a location accessible by training system 102, or both.

Task information 114 may include any information identifying various characteristics of task 124 which trainee 106 has been assigned to perform and that may be used by training system 102 to identify training 104 for trainee 106. For example, without limitation, task information 114 may include flight information 126 identifying various characteristics of flight 128 to which flight crew member 108 has been assigned. In this case, flight information 126 may include any information identifying various characteristics of flight 128 to which flight crew member 108 has been assigned that may be used by training system 102 to identify training 104 for flight crew member 108.

Task information 114 may be received by training system 102 from number of information sources 130. For example, number of information sources 130 may include live information sources 132, stored information sources 134, or both. Live information sources 132 may include any source of information that may provide task information 114 that may be updated or otherwise changed more frequently than task information 114 that may be provided from stored information sources 134. For example, without limitation, live information sources 132 may include sources of information that may provide task information 114 to training system 102 in real-time or in near real-time as task information 114 is generated by live information sources 132. Stored information sources 134 may include information stored in training system 102, information stored outside of training system 102 but accessible by training system 102, or both.

For example, without limitation, task information 114 may be flight information 126 that includes weather information identifying weather that may affect flight 128 to which flight crew member 108 is assigned, aircraft information identifying characteristics of the aircraft to be used for flight 128, or various other information or combinations of information identifying various characteristics of flight 128. In this example, the weather information identifying weather that may affect flight 128 may change relatively frequently and is an example of task information 114 that may be provided by live information sources 132, such as a weather radar or weather forecasting system. In this example, the aircraft information identifying characteristics of the aircraft to be used for flight 128 may change relatively infrequently and may be an example of task information 114 that may be provided from stored information sources 134, such as a database of aircraft information.

In accordance with an illustrative embodiment, training system 102 may use trainee information 112, task information 114, or both, to identify training 104 for trainee 106 in accordance with rules 136. Rules 136 may be established by an airline, a regulation entity, or another entity or various combinations of entities.

Rules 136 may define how trainee information 112, task information 114, or both may be used to select selected course 116 from plurality of training courses 110, to determine priority 118 for plurality of training courses 110, or both. For example, without limitation, rules 136 may be defined and applied by training system 102 so that the likelihood that any one of plurality of training courses 110 is selected as selected course 116 is higher if flight information 126 indicates that training provided by the one of plurality of training courses 110 is more likely to be used by flight crew member 108 during flight 128 to which flight crew member 108 is assigned. As another example, without limitation, rules 136 may be defined and applied by training system 102 so that courses in plurality of training courses 110 are given higher priority in priority 118 for plurality of training courses 110 if flight information 126 indicates that training provided by such courses is more likely to be used by flight crew member 108 during flight 128 to which flight crew member 108 may be assigned.

Rules 136 may be represented and implemented by training system 102 in any appropriate manner. For example, without limitation, rules 136 may define various weights that may be assigned to plurality of training courses 110 based on trainee information 112, task information 114, or both. These assigned weights then may be used by training system 102 to select selected course 116 from plurality of training courses 110, to identify priority 118 for plurality of training courses 110, or in another manner to identify training 104 for trainee 106.

Trainee 106 may interact with training system 102 via trainee data processing system 138. Trainee data processing system 138 may be a desk top computer or any other appropriate type of computer. For example, without limitation, trainee data processing system 138 may be any appropriate personal electronic device 140. Personal electronic device 140 may be a laptop computer, hand held data processing device, or any other appropriate data processing device. In cases where trainee 106 is flight crew member 108, such as a pilot or another member of a flight crew, trainee data processing system 138 may be electronic flight bag 142.

Trainee data processing system 138 may be connected to training system 102 via any appropriate wired or wireless connection. For example, without limitation, trainee data processing system 138 may be connected to transmit information to training system 102 and to receive information from training system 102 via any appropriate data processing system network, such as the Internet or any other appropriate network.

Trainee 106 may access training system 102 by using trainee data processing system 138 to provide trainee identification information 144 to training system 102. Trainee identification information 144 may include any appropriate information for identifying trainee 106 to training system 102. Trainee identification information 144 may be used by training system 102 to identify trainee information 112 for trainee 106 that may be used by training system 102 to identify training 104 for trainee 106. Alternatively, or additionally, some or all of trainee information 112 may be provided by trainee 106 to training system 102 using trainee data processing system 138. In this case, trainee identification information 144 may include trainee information 112 that may be used by training system 102 to identify training 104 for trainee 106.

Trainee 106 also may use trainee data processing system 138 to provide task identification information 146 to training system 102. Task identification information 146 may include any appropriate information for identifying task 124 to be performed by trainee 106 to training system 102. For example, without limitation, task identification information 146 may include flight identification information 148 for identifying flight 128 to which flight crew member 108 may be assigned. Task identification information 146 may be used by training system 102 to identify task information 114 that may be used by training system 102 to identify training 104 for trainee 106. For example, without limitation, task identification information 146 may be used by training system 102 to retrieve, request, access, or otherwise obtain task information 114 from number of information sources 130. Alternatively, or additionally, some or all of task information 114 may be provided by trainee 106 to training system 102 using trainee data processing system 138. In this case, task identification information 146 may include task information 114 that may be used by training system 102 to identify training 104 for trainee 106.

Training system 102 may be configured to generate training notification 150 and to provide training notification 150 to trainee 106. Training notification 150 may be provided in any appropriate manner and format to indicate to trainee 106 training 104 that has been identified by training system 102 for trainee 106. For example, without limitation, training notification 150 may be provided to trainee 106 in the form of an electronic message that may be received, accessed, or otherwise viewed by trainee 106 using trainee data processing system 138.

Trainee 106 may respond to training notification 150 by taking training 104 as identified by training system 102 and as indicated in training notification 150. Trainee 106 may take training 104 as identified by training system 102 and as indicated in training notification 150 in any appropriate manner. For example, without limitation, training system 102 may be configured to deliver training 104 to trainee 106 via trainee data processing system 138 or in any other appropriate manner.

Training system 102 may be configured to generate training report 154. For example, without limitation, training report 154 may include training identification 156. Training identification 156 may include information indicating training 104 that was identified by training system 102 for trainee 106. Training report 154 also may include indication of completion 158. Indication of completion 158 may include information that identifies whether trainee 106 has completed training 104 that was identified by training system 102 for trainee 106 as indicated by training identification 156. For example, without limitation, indication of completion 158 may indicate whether trainee 106 has completed training 104, the manner in which trainee 106 may have completed training 104, when trainee 106 may have completed training 104, or other information or various combinations of information related to the completion of training 104 by trainee 106.

Information for generating indication of completion 158 may be provided to training system 102 by trainee 106. For example, without limitation, trainee 106 may use trainee data processing system 138 to provide information for indication of completion 158 to training system 102 as trainee 106 completes training 104. Alternatively, or additionally, indication of completion 158 may be updated automatically by training system 102 as trainee 106 takes training 104 provided by training system 102 using trainee data processing system 138.

Training report 154 may be provided to trainee 106 in any appropriate manner and format. For example, without limitation, training report 154 may be provided by training system 102 to trainee 106 in the form of an electronic message or an electronic document or in any other appropriate format that may be received, accessed, or otherwise viewed by trainee 106 using trainee data processing system 138.

In accordance with an illustrative embodiment, operator 160 may manually affect or control the identification of training 104 for trainee 106 by training system 102 by providing manual training information 162 to training system 102. Operator 160 may be any human operator of training system 102 other than trainee 106. For example, without limitation, operator 160 may operate training system 102 for an airline or any other entity. Training system 102 may be configured to receive manual training information 162 from operator 160 in any appropriate manner.

Manual training information 162 may include any information that may affect the identification of training 104 for trainee 106 by training system 102. For example, without limitation, manual training information 162 may be used by training system 102 in combination with trainee information 112, task information 114, or both, to identify training 104 for trainee 106. As another example, in some cases, manual training information 162 may be used to override the automatic identification of training 104 by training system 102.

Training report 154 also may be provided to operator 160. Operator 160 may use the information provided in training report 154 to monitor training 104 identified by training system 102 for trainee 106 and to monitor the completion of training 104 by trainee 106. Training report 154 may be provided in any appropriate manner and format to operator 160.

In accordance with an illustrative embodiment, training 104 identified by training system 102 may comprise hints 164. Hints 164 may include pieces of training or other information that may help trainee 106 to complete task 124. Hints 164 may comprise less information than a course in plurality of training courses 110 and may be specific to task 124 to be performed by trainee 106. For example, in the case where trainee 106 is flight crew member 108, task 124 to be performed may be flight 128 to which flight crew member 108 is assigned. In this case, hints 164 may include information that may be useful for flight crew member 108 during flight 128. Hints 164 may be identified by training system 102 in the manner of training 104. For example, hints 164 may be identified by training system 102 using trainee information 112, task information 114, or both, in accordance with rules 136.

The illustration of FIG. 1 is not meant to imply physical or architectural limitations to the manner in which different illustrative embodiments may be implemented. Other components in addition to, in place of, or both in addition to and in place of the ones illustrated may be used. Some components may be unnecessary in some illustrative embodiments. Also, the blocks are presented to illustrate some functional components. One or more of these blocks may be combined or divided into different blocks when implemented in different illustrative embodiments.

For example, without limitation, trainee information 112 may be received by training system 102 from number of information sources 130. Trainee identification information 144 may be used by training system 102 to retrieve, request, access, or otherwise obtain trainee information 112 from number of information sources 130. Number of information sources 130 may include one or more of trainee 106, trainee data processing system 138, and operator 160 in any combination.

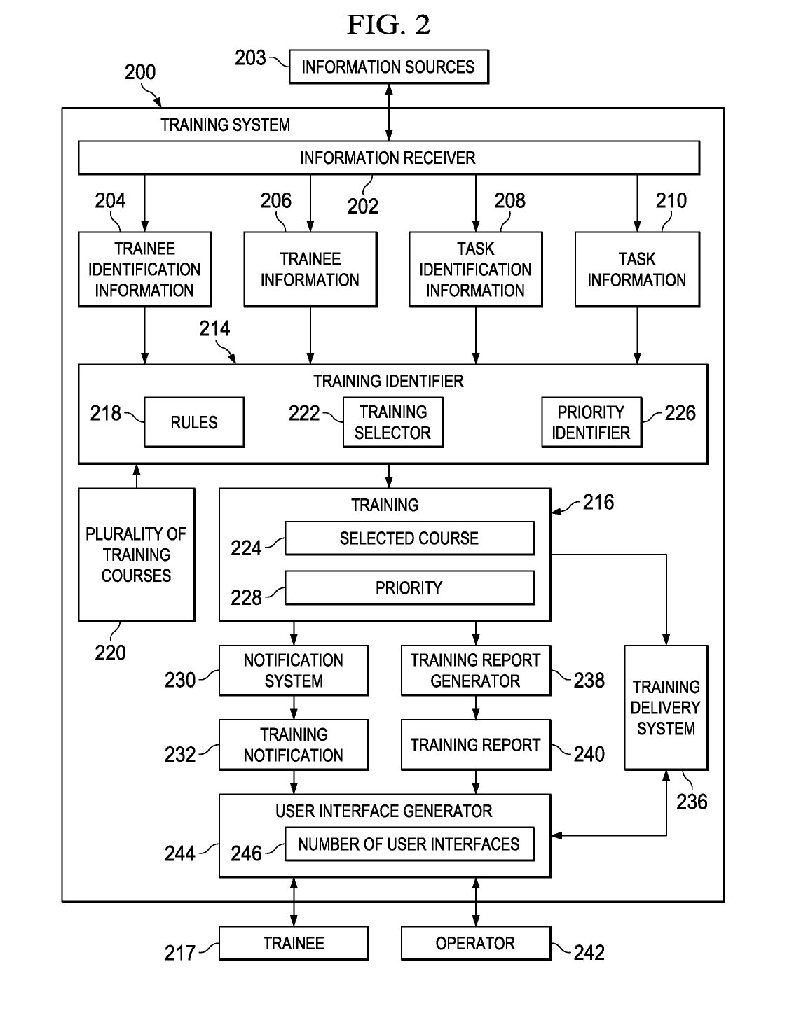

Turning now to FIG. 2, an illustration of a block diagram of a training system is depicted in accordance with an illustrative embodiment. In this example, training system 200 is an example of one implementation of training system 102 in FIG. 1. Training system 200 may be implemented in any appropriate data processing system to perform the various functions of training system 200 described herein.

Training system 200 may include information receiver 202. Information receiver 202 may be configured to receive various types of information from information sources 203. In this example, without limitation, information sources 203 may include number of information sources 130 in FIG. 1, including live information sources 132 and stored information sources 134. For example, without limitation, information receiver 202 may be configured to receive trainee identification information 204, trainee information 206, task identification information 208, task information 210, or various combinations of such information from information sources 203. Trainee identification information 204, trainee information 206, task identification information 208, task information 210, or various combinations of such information may be provided from information receiver 202 to training identifier 214.

Training identifier 214 may be configured to use trainee identification information 204, trainee information 206, task identification information 208, task information 210, or various combinations of such information to identify training 216 for trainee 217 in accordance with rules 218. For example, training identifier 214 may be configured to identify training 216 for trainee 217 from plurality of training courses 220. For example, without limitation, training identifier 214 may include training selector 222 that is configured to identify selected course 224 for trainee 217 from plurality of training courses 220 using trainee identification information 204, trainee information 206, task identification information 208, task information 210, or various combinations of such information in accordance with rules 218. As another example, without limitation, training identifier 214 may include priority identifier 226 that is configured to identify priority 228 for plurality of training courses 220 using trainee identification information 204, trainee information 206, task identification information 208, task information 210, or various combinations of such information in accordance with rules 218.

Training system 200 may include notification system 230. Notification system 230 may be configured to generate training notification 232. Training notification 232 may include information identifying training 216 for trainee 217 that is identified by training identifier 214.

Training system 200 may include training delivery system 236. Training delivery system 236 may be configured to deliver training 216 to trainee 217.

Training system 200 may include training report generator 238. Training report generator 238 may be configured to generate training report 240. Training report 240 may include information identifying training 216 for trainee that is identified by training identifier 214 along with information indicating whether training 216 has been completed by trainee 217. Training report 240 also may include information identifying the manner in which trainee 217 may have completed training 216, when trainee 217 may have completed training 216, or both. Training report 240 may be sent to trainee 217, operator 242, or both.

Training system 200 may include user interface generator 244. User interface generator 244 may be configured to generate number of user interfaces 246. Trainee 217, operator 242, or both may use number of user interfaces 246 to interact with training system 200.

The illustration of FIG. 2 is not meant to imply physical or architectural limitations to the manner in which different illustrative embodiments may be implemented. Other components in addition to, in place of, or both in addition to and in place of the ones illustrated may be used. Some components may be unnecessary in some illustrative embodiments. Also, the blocks are presented to illustrate some functional components. One or more of these blocks may be combined or divided into different blocks when implemented in different illustrative embodiments.

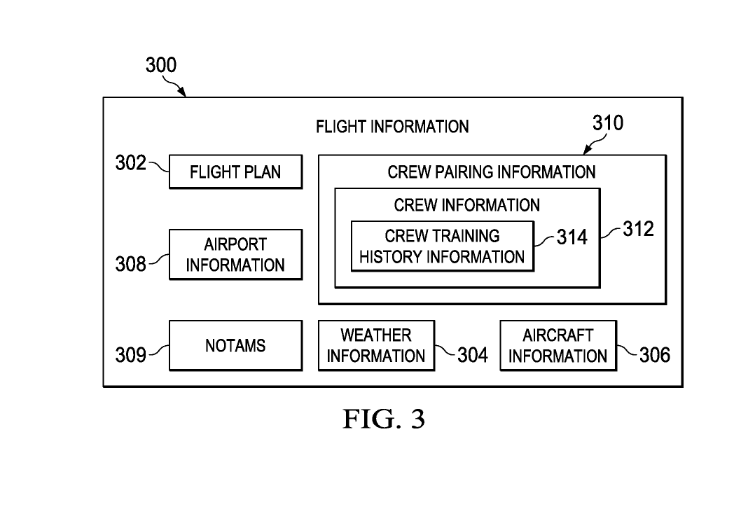

Turning now to FIG. 3, an illustration of a block diagram of flight information is depicted in accordance with an illustrative embodiment. In this example, flight information 300 is an example of flight information 126 in FIG. 1.

Flight information 300 may include information describing various characteristics of a flight and may be used to identify training for a flight crew member in accordance with an illustrative embodiment. For example, without limitation, flight information 300 may include flight plan 302, weather information 304, aircraft information 306, airport information 308, NOTAMs 309, and crew pairing information 310. Crew pairing information 310 may include crew information 312 for the members of the flight crew assigned to the flight. For example, without limitation, crew information 312 may include crew training history information 314.

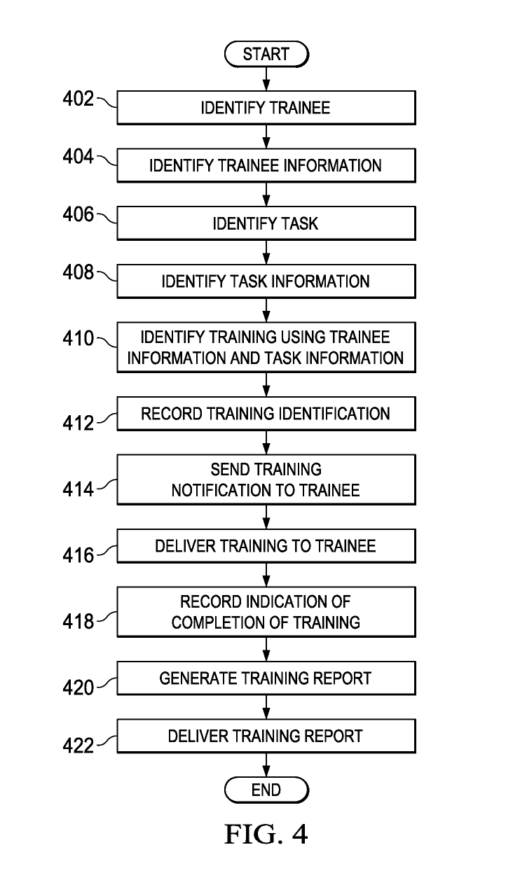

Turning now to FIG. 4, an illustration of a flowchart of a process for identifying training is depicted in accordance with an illustrative embodiment. The process of FIG. 4 may be implemented, for example, in training system 200 in FIG. 2.

The process may begin by identifying a trainee (operation 402). Trainee information for the identified trainee then may be identified (operation 404). A task may be identified (operation 406). Task information for the identified task may be identified (operation 408). Training for a trainee then may be identified using the trainee information and the task information (operation 410).

Training identification identifying the training identified in operation 410 may be recorded (operation 412). A training notification may be sent to the trainee (operation 414). The training may be delivered to the trainee (operation 416).

An indication that the trainee has completed the training may be recorded (operation 418). A training report may be generated (operation 420). The operation report may be delivered (operation 422), with the process terminating thereafter.

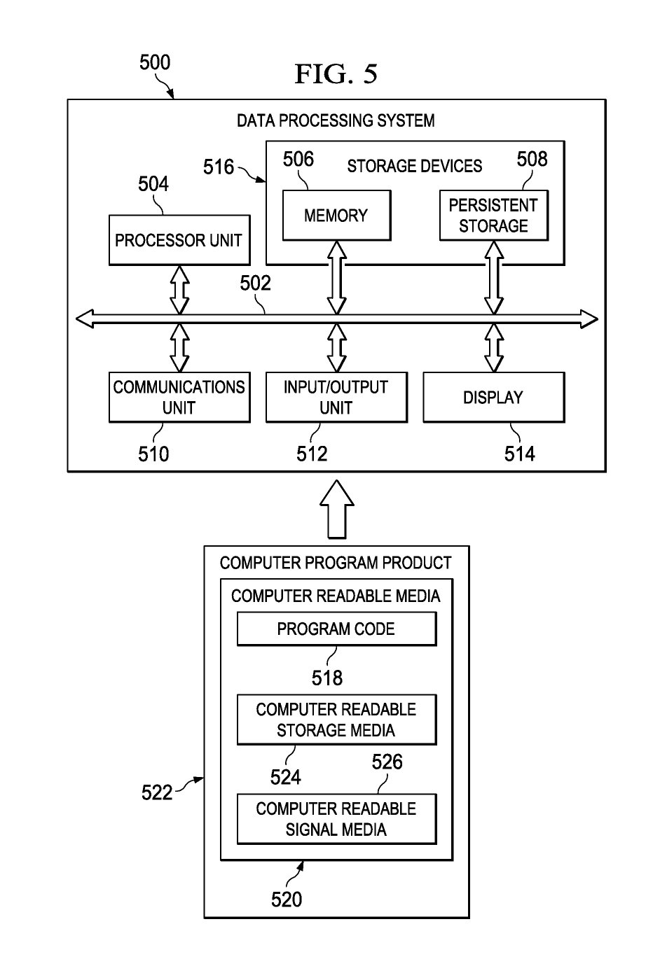

Turning now to FIG. 5, an illustration of a block diagram of a data processing system is depicted in accordance with an illustrative embodiment. In this example, data processing system 500 is an example of one implementation of a data processing system for implementing training system 102 or trainee data processing system 138 in FIG. 1, or for implementing training system 200 in FIG. 2.

In this illustrative example, data processing system 500 includes communications fabric 502. Communications fabric 502 provides communications between processor unit 504, memory 506, persistent storage 508, communications unit 510, input/output (I/O) unit 512, and display 514. Memory 506, persistent storage 508, communications unit 510, input/output (I/O) unit 512, and display 514 are examples of resources accessible by processor unit 504 via communications fabric 502.

Processor unit 504 serves to run instructions for software that may be loaded into memory 506. Processor unit 504 may be a number of processors, a multi-processor core, or some other type of processor, depending on the particular implementation. Further, processor unit 504 may be implemented using a number of heterogeneous processor systems in which a main processor is present with secondary processors on a single chip. As another illustrative example, processor unit 504 may be a symmetric multi-processor system containing multiple processors of the same type.

Memory 506 and persistent storage 508 are examples of storage devices 516. A storage device is any piece of hardware that is capable of storing information, such as, for example, without limitation, data, program code in functional form, and other suitable information either on a temporary basis or a permanent basis. Storage devices 516 also may be referred to as computer readable storage devices in these examples. Memory 506, in these examples, may be, for example, a random access memory or any other suitable volatile or non-volatile storage device. Persistent storage 508 may take various forms, depending on the particular implementation.

For example, persistent storage 508 may contain one or more components or devices. For example, persistent storage 508 may be a hard drive, a flash memory, a rewritable optical disk, a rewritable magnetic tape, or some combination of the above. The media used by persistent storage 508 also may be removable. For example, a removable hard drive may be used for persistent storage 508.

Communications unit 510, in these examples, provides for communications with other data processing systems or devices. In these examples, communications unit 510 is a network interface card. Communications unit 510 may provide communications through the use of either or both physical and wireless communications links.

Input/output (I/O) unit 512 allows for input and output of data with other devices that may be connected to data processing system 500. For example, input/output (I/O) unit 512 may provide a connection for user input through a keyboard, a mouse, and/or some other suitable input device. Further, input/output (I/O) unit 512 may send output to a printer. Display 514 provides a mechanism to display information to a user.

Instructions for the operating system, applications, and/or programs may be located in storage devices 516, which are in communication with processor unit 504 through communications fabric 502. In these illustrative examples, the instructions are in a functional form on persistent storage 508. These instructions may be loaded into memory 506 for execution by processor unit 504. The processes of the different embodiments may be performed by processor unit 504 using computer-implemented instructions, which may be located in a memory, such as memory 506.

These instructions are referred to as program instructions, program code, computer usable program code, or computer readable program code that may be read and executed by a processor in processor unit 504. The program code in the different embodiments may be embodied on different physical or computer readable storage media, such as memory 506 or persistent storage 508.

Program code 518 is located in a functional form on computer readable media 520 that is selectively removable and may be loaded onto or transferred to data processing system 500 for execution by processor unit 504. Program code 518 and computer readable media 520 form computer program product 522 in these examples. In one example, computer readable media 520 may be computer readable storage media 524 or computer readable signal media 526.

Computer readable storage media 524 may include, for example, an optical or magnetic disk that is inserted or placed into a drive or other device that is part of persistent storage 508 for transfer onto a storage device, such as a hard drive, that is part of persistent storage 508. Computer readable storage media 524 also may take the form of a persistent storage, such as a hard drive, a thumb drive, or a flash memory, that is connected to data processing system 500. In some instances, computer readable storage media 524 may not be removable from data processing system 500.

In these examples, computer readable storage media 524 is a physical or tangible storage device used to store program code 518 rather than a medium that propagates or transmits program code 518. Computer readable storage media 524 is also referred to as a computer readable tangible storage device or a computer readable physical storage device. In other words, computer readable storage media 524 is a media that can be touched by a person.

Alternatively, program code 518 may be transferred to data processing system 500 using computer readable signal media 526. Computer readable signal media 526 may be, for example, a propagated data signal containing program code 518. For example, computer readable signal media 526 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 518 may be downloaded over a network to persistent storage 508 from another device or data processing system through computer readable signal media 526 for use within data processing system 500. For instance, program code stored in a computer readable storage medium in a server data processing system may be downloaded over a network from the server to data processing system 500. The data processing system providing program code 518 may be a server computer, a client computer, or some other device capable of storing and transmitting program code 518.

The different components illustrated for data processing system 500 are not meant to provide architectural limitations to the manner in which different embodiments may be implemented. The different illustrative embodiments may be implemented in a data processing system including components in addition to and/or in place of those illustrated for data processing system 500. Other components shown in FIG. 5 can be varied from the illustrative examples shown. The different embodiments may be implemented using any hardware device or system capable of running program code. As one example, data processing system 500 may include organic components integrated with inorganic components and/or may be comprised entirely of organic components excluding a human being. For example, a storage device may be comprised of an organic semiconductor.

In another illustrative example, processor unit 504 may take the form of a hardware unit that has circuits that are manufactured or configured for a particular use. This type of hardware may perform operations without needing program code to be loaded into a memory from a storage device to be configured to perform the operations.

For example, when processor unit 504 takes the form of a hardware unit, processor unit 504 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 518 may be omitted, because the processes for the different embodiments are implemented in a hardware unit.

In still another illustrative example, processor unit 504 may be implemented using a combination of processors found in computers and hardware units. Processor unit 504 may have a number of hardware units and a number of processors that are configured to run program code 518. With this depicted example, some of the processes may be implemented in the number of hardware units, while other processes may be implemented in the number of processors.

In another example, a bus system may be used to implement communications fabric 502 and may be comprised of one or more buses, such as a system bus or an input/output bus. Of course, the bus system may be implemented using any suitable type of architecture that provides for a transfer of data between different components or devices attached to the bus system.

Additionally, communications unit 510 may include a number of devices that transmit data, receive data, or both transmit and receive data. Communications unit 510 may be, for example, a modem or a network adapter, two network adapters, or some combination thereof. Further, a memory may be, for example, memory 506, or a cache, such as that found in an interface and memory controller hub that may be present in communications fabric 502.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

The description of the different illustrative embodiments has been presented for purposes of illustration and description and is not intended to be exhaustive or to limit the embodiments in the form disclosed. Many modifications and variations will be apparent to those of ordinary skill in the art. Further, different illustrative embodiments may provide different benefits as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for identifying training for a flight crew member, comprising:
identifying, by a processor unit, the flight crew member;
identifying, by the processor unit, flight information for a flight to which the flight crew member is assigned; and
identifying, by the processor unit, training for the flight crew member using the flight information.

2. The method of claim 1 further comprising receiving, by the processor unit, input from an operator comprising manual training information and wherein identifying training for the flight crew member comprises identifying training for the flight crew member using the manual training information.

3. The method of claim 1, wherein the flight information comprises information identifying characteristics of the flight selected from a flight plan, weather information for the flight, aircraft information, airport information, and crew pairing information for the flight.

4. The method of claim 1, wherein identifying training for the flight crew member comprises:
identifying, by the processor unit, a plurality of training courses that are desirable for the flight crew member to take; and
identifying, by the processor unit, a selected course from the plurality of training courses using the flight information.

5. The method of claim 1, wherein identifying training for the flight crew member comprises:
identifying, by the processor unit, a plurality of training courses that are desirable for the flight crew member to take; and
identifying a priority for the plurality of training courses for the flight crew member using the flight information.

6. The method of claim 1, further comprising sending a training notification identifying the training to the flight crew member.

7. The method of claim 1, further comprising delivering the training to the flight crew member via a data processing system.

8. The method of claim 7, wherein the training comprises hints for the flight.

9. The method of claim 1, further comprising recording a training identification identifying the training and recording an indication of completion of the training in response to the flight crew member completing the training.

10. An apparatus, comprising:
an information receiver configured to receive task information identifying characteristics of a task to be performed by a trainee; and
a training identifier configured to identify training for the trainee using the task information.

11. The apparatus of claim 10, wherein the training identifier comprises a training selector configured to identify a selected course from a plurality of training courses using the task information.

12. The apparatus of claim 10, wherein the training identifier comprises a priority identifier configured to identify a priority for a plurality of training courses using the task information.

13. The apparatus of claim 10, further comprising a notification system configured to send a training notification identifying the training to the trainee.

14. The apparatus of claim 10, further comprising a training delivery system configured to deliver the training to the trainee via a data processing system.

15. The apparatus of claim 10, further comprising a training report generator configured to generate a training report including a training identification identifying the training and an indication of completion of the training indicating whether the trainee completed the training.

16. The apparatus of claim 10, wherein:
the trainee is a flight crew member;
the task is a flight to which the flight crew member is assigned; and
the task information comprises information identifying characteristics of the flight selected from a flight plan, weather information for the flight, aircraft information, airport information, and crew pairing information for the flight.

17. A method for identifying training for a trainee, comprising:
identifying, by a processor unit, the trainee;
identifying, by the processor unit, task information identifying characteristics of a task to be performed by the trainee; and
identifying, by the processor unit, training for the trainee using the task information.

18. The method of claim 17, wherein identifying training for the trainee comprises:
identifying, by the processor unit, a plurality of training courses that are desirable for the trainee to take; and
identifying, by the processor unit, a selected course from the plurality of training courses using the task information.

19. The method of claim 17, wherein identifying training for the trainee comprises:
identifying, by the processor unit, a plurality of training courses that are desirable for the trainee to take; and
identifying a priority for the plurality of training courses for the trainee using the task information.

20. The method of claim 17, further comprising sending a training notification identifying the training to the trainee.
